(19) United States
(12) Patent Application Publication
(10) Pub. No.: US 2011/0115451 A1
(43) Pub. Date: May 19, 2011

(54) DRIVING METHOD OF SWITCHING ELEMENT AND POWER SUPPLY UNIT

(75) Inventors: Takayuki HASHIMOTO, Tokai (JP); Masahiro MASUNAGA, Hitachi (JP)

(73) Assignee: RENESAS ELECTRONICS CORPORATION, Kanagawa (JP)

(21) Appl. No.: 12/945,926

(22) Filed: Nov. 15, 2010

(30) Foreign Application Priority Data
Nov. 18, 2009 (JP) 2009-262451

(51) Int. Cl. G05F 1/10

(52) U.S. Cl. 323/272

(57) ABSTRACT

In a power supply unit, a main MOS and a sub MOS connected in parallel in a low-side power MOSFET section, a sensing MOS which is provided on a same semiconductor substrate with the low-side power MOSFET section, detects information corresponding to a load of the low-side power MOSFET section and is smaller in number than the transistors connected in parallel of the low-side power MOSFET section, and a control section for driving the main MOS and the sub MOS based on the information detected by the sensing MOS are provided.

### CROSS-REFERENCE TO RELATED APPLICATION

The present application claims priority from Japanese Patent Application No. 2009-262451 filed on Nov. 18, 2009, the content of which is hereby incorporated by reference to this application.

### TECHNICAL FIELD OF THE INVENTION

The present invention relates to a driving method of a switching element and a power supply unit, and more particularly to downsizing of a chip in a synchronous rectifier circuit used in an electronic device and others.

### BACKGROUND OF THE INVENTION

The power supply unit shown in FIG. 13 is known as a power supply unit conventionally used in an electronic device and others.

In the power supply unit shown in FIG. 13, the DC power input from a DC input power supply 60 to an input section 51 including an input capacitor 61 is switched in a switching section 52 including an active element 62 based on a control signal output from a driving section 70 of a control section 54, and the power is supplied to a load 66 from an output section 53 including a commutating diode 63 and an output filter 55.

The voltage and current output to the load 66 are detected in a detecting section 67, a detection value thereof and a control target value of the load 66 set in a setting section 68 are compared in a comparison operation section 69, and a control signal based on the comparison result is output from the driving section 70 to the switching section 52. In this manner, the power supplied to the load is controlled so as to coincide with the control target value.

FIG. 14 shows the specific circuit configuration of the power supply unit described above.

As shown in FIG. 14, the switching section 52 is made up of an active element (for example, transistor, MOSFET or others) 62. The output section 53 is made up of the commutating diode 63 and the output filter including a choke coil 64 and a smoothing capacitor 65. The control section 54 is made up of the comparison operation section 69, the setting section 68 and the driving section 70.

Furthermore, the control section 54 has an oscillating circuit (not shown) and outputs a pulse signal from the driving section 70 to the active element 62. By this means, the DC voltage Vin from the DC input power supply 60 applied to the active element 62 is switched.

When the active element 62 is in an on state, the DC power is charged in the choke coil 64 and the smoothing capacitor 65 and is supplied to the load 66. When the active element 62 is in an off state, the energy charged in the choke coil 64 and the smoothing capacitor 65 is supplied to the load 66 via the commutating diode 63.

At this time, in the control section 54, the comparison operation section 69 monitors the output voltage V0 detected by the detecting section 67 and compares the output voltage V0 with the control target value set in the setting section 68, and the control signal based on the comparison result is output to the switching section 52 from the driving section 70. By this means, the on/off control of the active element 62 is performed, and the power supplied to the load 66 is controlled so as to coincide with the control target value. The output voltage V0 at this time is expressed by the following expression (1).

Vo=VIN×(TON/T) (1)

Here, VIN denotes the DC input power supply 60, T denotes the period of the pulse signal output from the driving section 70, and TON denotes a conduction time of the active element 62 in the period T. More specifically, TON/T denotes the duty ratio.

Incidentally, a diode which is a passive element is usually used for the commutation side of the output section 53 as shown in FIG. 14, but the commutating diode 63 has the current-voltage characteristics as shown in FIG. 15, and the forward voltage is saturated when the current reaches a predetermined value or more.

The saturation voltage is 0.9 V to 1.3 V in a fast diode and is 0.45 V to 0.55 V in a Schottky diode. As described above, there has been a problem of the deterioration of the power conversion efficiency due to the power loss caused by the saturation of the forward voltage of the commutating diode 63.

Furthermore, since the junction temperature of the element increases due to the high power loss, there has been a problem that the junction temperature has to be suppressed by connecting many (two, three or others) commutating diodes 63 in parallel so as to distribute the power loss per one element as the output current becomes higher.

For the solution of these problems, the power supply unit of the synchronous rectification type in which a MOSFET 3 is used on the commutation side as shown in FIG. 16 has been conventionally known.

This utilizes the facts that the current-voltage characteristics of the MOSFET becomes linear depending on the gate voltage unlike the non-linear current-voltage characteristics of the diode and the voltage drop of the MOSFET is smaller than that of the diode as shown in FIG. 17.

The power supply unit shown in FIG. 16 is provided with a high-side power MOSFET 2 for switching, and a control signal is input from a control circuit 8 to a gate terminal of the MOSFET 2. When the MOSFET 2 is in a conduction state, the input power is charged in a smoothing capacitor 5 and supplied to a load 6 through a choke coil 4.

Next, when the MOSFET 2 is brought into a non-conduction state, magnetic energy stored in the choke coil 4 is discharged, and the commutation current flows in a detection resistor 7 and a parasitic diode 3A via the smoothing capacitor 5 and the load 6.

At this time, a voltage drop is caused by the detection resistor 7, and this voltage drop taken as a detection voltage is compared with a reference voltage Vref output from a reference voltage power supply 82 by a comparator 80. Then, when the detection voltage is higher than the reference voltage, the comparator 80 outputs a high level to render the MOSFET 3 conductive via a driving circuit 81.

The conversion efficiency (output voltage/input voltage) η of this power supply circuit is gradually lowered with the increase of the output current Io as shown in FIG. 18. This is because the power loss PFET of the MOSFET expressed by the following expression (2) increases in proportion to the square of the drain current ID under the constant on-resistance Ron.

PFET=Ron×ID²=(Ron×ID)×ID (2)

For the solution of this problem, Japanese utility model application publication No. 6-44396 (Patent Document 1) suggests a technology of halving the on-resistance by connecting the MOSFETs in parallel.

However, since two MOSFETs are always driven simultaneously in such a power supply unit, the required driving power is doubled, and although it is possible to improve the efficiency in the heavy load (=region in which output current Io is high), the loss in the light load (=region in which output current Io is low) is relatively increased and the efficiency is lowered.

For the solution of this problem, Japanese Patent Application Laid-Open Publication No. 2006-211760 (Patent Document 2) suggests a technology of controlling the number of MOSFETs to be turned on out of the MOSFETs connected in parallel depending on the output current.

In this technology, at least one MOSFET is selected and driven depending on the output current. For example, in the case where a plurality of switching elements all have the same characteristics, that is, the magnitude of the current to be delivered is the same, one switching element is driven when the output current is low, that is, in the light load, and the number of switching elements to be driven is increased as the output current becomes higher, that is, the load becomes heavier.

The unnecessary waste of the driving power can be prevented by driving only one switching element in the light load, and the conduction loss of the switching elements can be reduced by driving a plurality of switching elements in the heavy load. Therefore, the power supply efficiency can be improved over the heavy load from the light load.

### SUMMARY OF THE INVENTION

However, the Patent Document 2 does not describe the detecting means of the output current. The following three means are generally known as the detecting means of the output current.

That is, (1) a shunt resistor, (2) voltage between a source and a drain of a MOSFET, and (3) a sensing MOSFET.

Although (1) the shunt resistor has high current detection accuracy, it has a problem of high conduction loss generated in the resistor.

Meanwhile, (2) the voltage between a source and a drain of a MOSFET is a method of calculating the drain current by detecting the voltage between a source and a drain of a MOSFET, and although no loss is generated, the method has a problem of low detection accuracy. The reason for the low detection accuracy is that the on-resistance of a power MOSFET is as low as several mΩ and the voltage drop between a source and a drain is as low as several mV in the light load when the output current is about 1 A.

Unlike these two methods described above, (3) the sensing MOSFET is known as a method capable of achieving both the low loss and the high detection accuracy. For example, the documents relating to the sensing MOSFET include Japanese Patent Application Laid-Open Publication No. 2009-75957 (Patent Document 3) and H. Takaya et al., “Current-sensing power MOSFETs with excellent temperature characteristics” in proc. IEEE ISPSD '09, June 2009, pp. 73-76 (Non-Patent Document 1).

FIG. 19 is a block diagram showing an example in which two power MOSFETs are connected in parallel and a sensing MOSFET for detecting the output current is mounted for each of the power MOSFETs.

A power MOSFET section 21 is made up of a main MOS 22 which is always operated and a sub MOS 23 whose operation is stopped in the light load. The main MOS 22 is driven by a first gate 24 and the sub MOS 23 is driven by a second gate 26.

A first sensing MOS 25 is mounted in the main MOS 22 and a second sensing MOS 91 is mounted in the sub MOS 23. The currents of the first and second sensing MOSs are converted to voltages (v1, v2) by current detection circuits 32 and 92. The voltages (v1, v2) have values proportional to respective drain currents Id of the main MOS 22 and the sub MOS 23.

The output voltages (v1, v2) of the current detection circuits (32, 92) are added by an adder 93 (v1+v2) and then compared with a reference voltage Vref, and “operate both of the main MOS 22 and the sub MOS 23” or “operate only the main MOS 22” is selected by a gate voltage control circuit 34 to drive the power MOSFET section 21.

As described above, in the conventional case, when two power MOSFETs are connected in parallel, the first sensing MOS 25 and the second sensing MOS 91 are provided to both of the main MOS 22 and the sub MOS 23 in order to perform the control by detecting all output currents.

However, there are two following problems in the above-described technology.

That is, (a) since there are two sensing MOSs in the power MOSFET section 21, the chip size of the power MOSFET is large, and

(b) since there are two current detection circuits in the control section 31, the chip size of the control IC is large.

The large chip size of the power MOSFET and the control IC leads to the increase in size and cost of the power supply unit.

Therefore, an object of the present invention is to provide a driving method of a switching element capable of detecting a current with high accuracy without increasing cost, in a driving method in which the number of power MOSFETs to be operated out of the power MOSFETS connected in parallel is reduced in the light load.

The above and other objects and novel characteristics of the present invention will be apparent from the description of the present specification and the accompanying drawings.

The following is a brief description of an outline of the typical invention disclosed in the present application.

That is, an outline of the typical invention is a driving method of a switching element in which the second switching element is made up of two or more transistors connected in parallel, detects information corresponding to a load of the second switching element by a sensing transistor which is provided on a same semiconductor substrate with the second switching element and is smaller in number than the transistors connected in parallel of the second switching element, and then outputs the information to the control section, and the control section makes control based on the information detected by the sensing transistor so as to increase the number of transistors in an off state as the load of the second switching element becomes lighter.

The effect obtained by typical embodiments of the invention disclosed in the present application will be briefly described below.

That is, as the effect obtained by typical embodiments, in the driving of power MOSFETs in which power MOSFETs are connected in parallel and the number of operating power MOSFETs connected in parallel is reduced when an output current of a power supply is reduced, a sensing MOS for detecting the current is mounted in only a main MOS, whereby the current can be detected with high accuracy without increasing the chip sizes of the power MOSFET and the IC of a control circuit.

### BRIEF DESCRIPTIONS OF THE DRAWINGS

FIG. 1 is a block diagram showing the main configuration of the power supply unit according to the first embodiment of the present invention;

FIG. 2 is a diagram showing an output current waveform in the operation of the power supply unit according to the first embodiment of the present invention;

FIG. 3 is a diagram showing an input and an output of a hysteresis comparator in the operation of the power supply unit according to the first embodiment of the present invention;

FIG. 4 is a diagram showing the relation between the output current and the loss in the operation of the power supply unit according to the first embodiment of the present invention;

FIG. 5 is a diagram showing the relation between the output current and the loss in the operation of the power supply unit according to the first embodiment of the present invention;

FIG. 6 is a circuit configuration diagram showing the circuit configuration of the power supply unit according to the first embodiment of the present invention;

FIG. 7 is a circuit configuration diagram showing the circuit configuration of the power supply unit according to the second embodiment of the present invention;

FIG. 8 is an explanatory diagram for describing the loss in the case where the area ratio of the main MOS and the sub MOS is set to 1:4 in the power supply unit according to the second embodiment of the present invention;

FIG. 9 is a block diagram showing the main configuration of the power supply unit according to the third embodiment of the present invention;

FIG. 10 is a diagram showing an output current waveform in the operation of the power supply unit according to the third embodiment of the present invention;

FIG. 11 is a diagram showing the relation between the number of MOSFETs and the reference voltage of the comparator in the operation of the power supply unit according to the third embodiment of the present invention;

FIG. 12 is a block diagram showing the main configuration of the power supply unit according to the fourth embodiment of the present invention;

FIG. 13 is a schematic configuration diagram of a conventional power supply unit;

FIG. 14 is a circuit configuration diagram of a conventional power supply unit;

FIG. 15 is a diagram showing current-voltage characteristics of a diode;

FIG. 16 is a circuit configuration diagram of a conventional power supply unit;

FIG. 17 is a diagram showing current-voltage characteristics of a MOSFET;

FIG. 18 is a diagram showing a relation between an output current and a conversion efficiency of a conventional power supply unit; and

FIG. 19 is a block diagram showing a configuration of a conventional power supply unit.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiments, and the repetitive description thereof will be omitted.

### First Embodiment

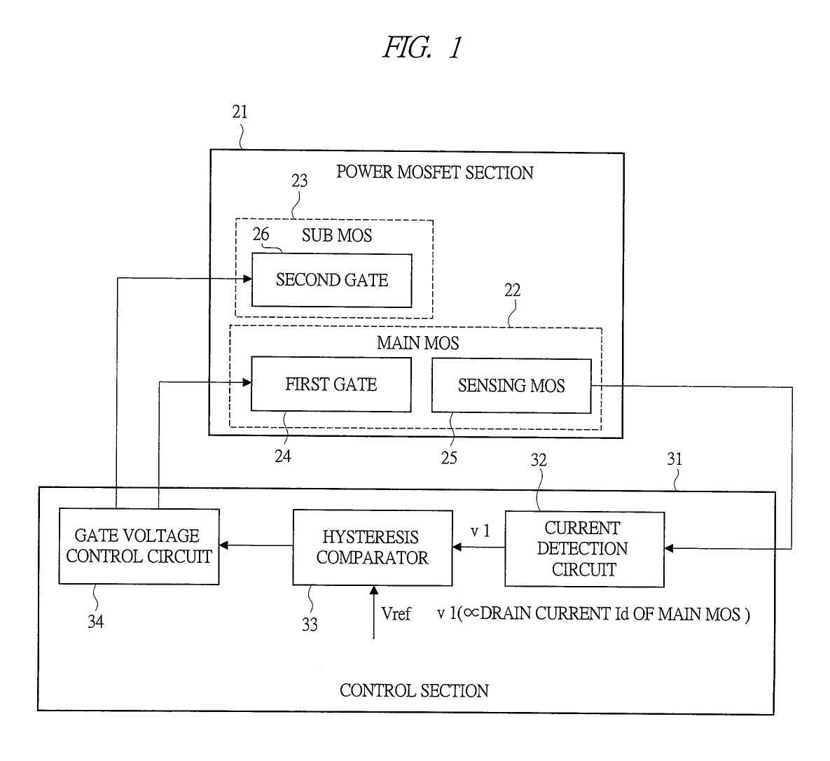

The main configuration of a power supply unit according to the first embodiment of the present invention will be described with reference to FIG. 1. FIG. 1 is a block diagram showing the main configuration of the power supply unit according to the first embodiment of the present invention, and it shows only the periphery of a low-side power MOSFET.

In FIG. 1, the configuration of the periphery of the low-side power MOSFET of the power supply unit includes a low-side power MOSFET section 21 functioning as a switching element and a control section 31.

The power MOSFET section 21 is made up of a main MOS 22 which is always operated and a sub MOS 23 whose operation is stopped in the light load. The main MOS 22 is driven by a first gate 24, the sub MOS 23 is driven by a second gate 26, and a sensing MOS 25 is mounted in only the main MOS 22.

The control section 31 is made up of a current detection circuit 32, a hysteresis comparator 33 and a gate voltage control circuit 34.

In the present embodiment, since the number of sensing MOSFETs and current detection circuits is smaller than that of the conventional technology shown in FIG. 19, the chip sizes of the power MOSFET and the IC of the control section are reduced, and the current can be detected with high accuracy without increasing the cost.

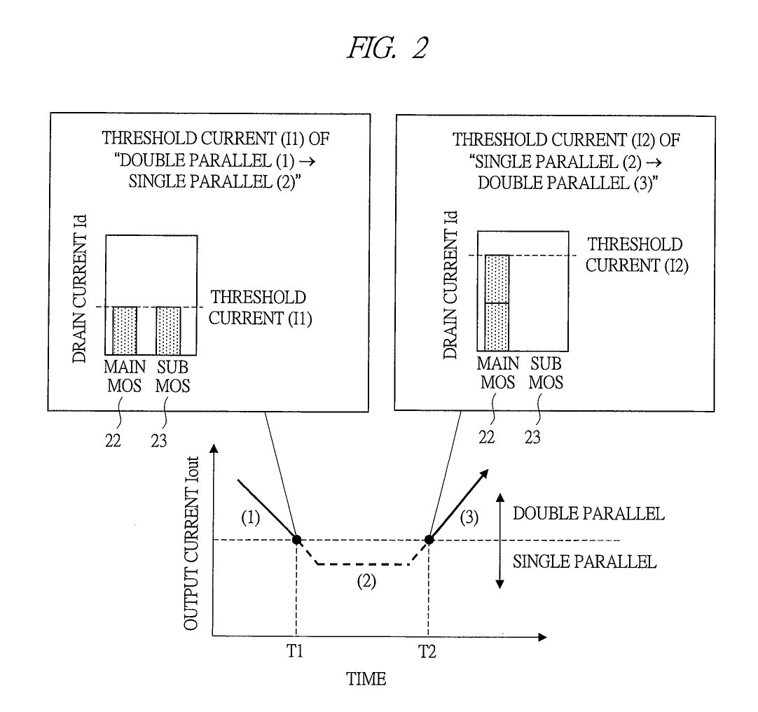

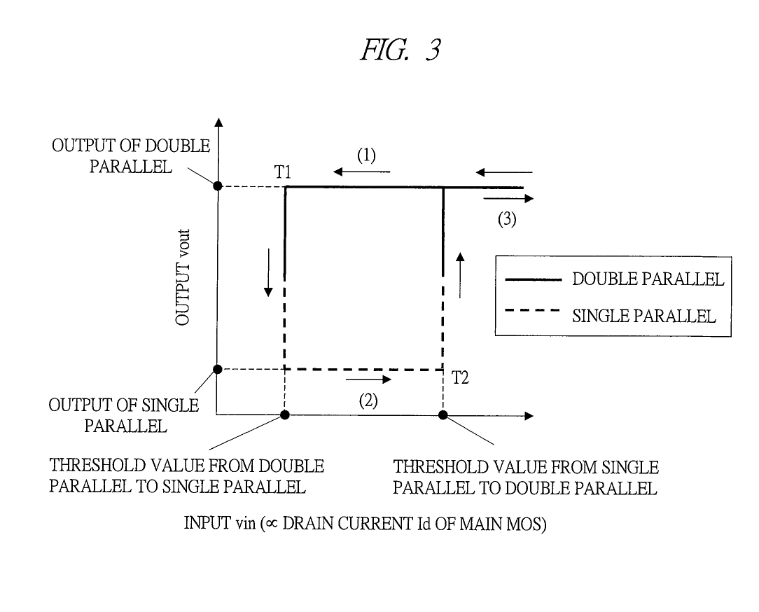

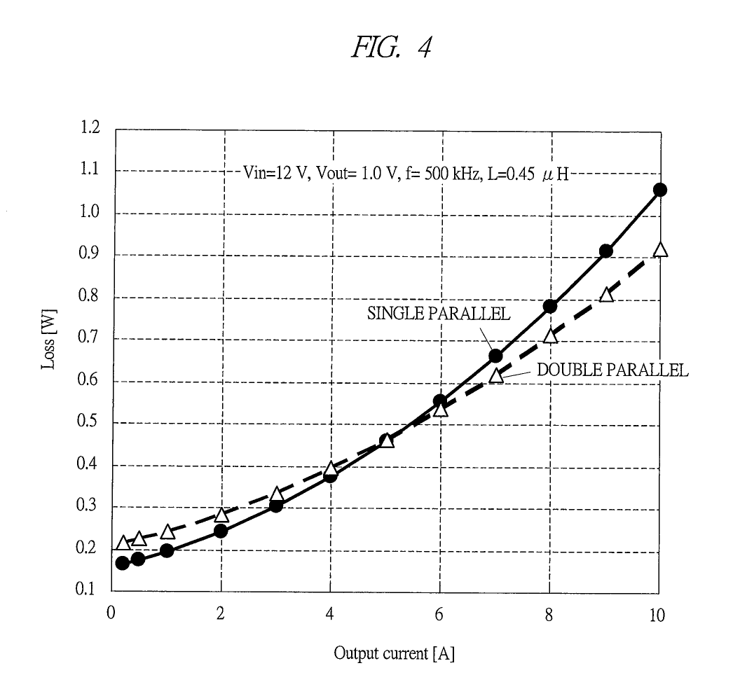

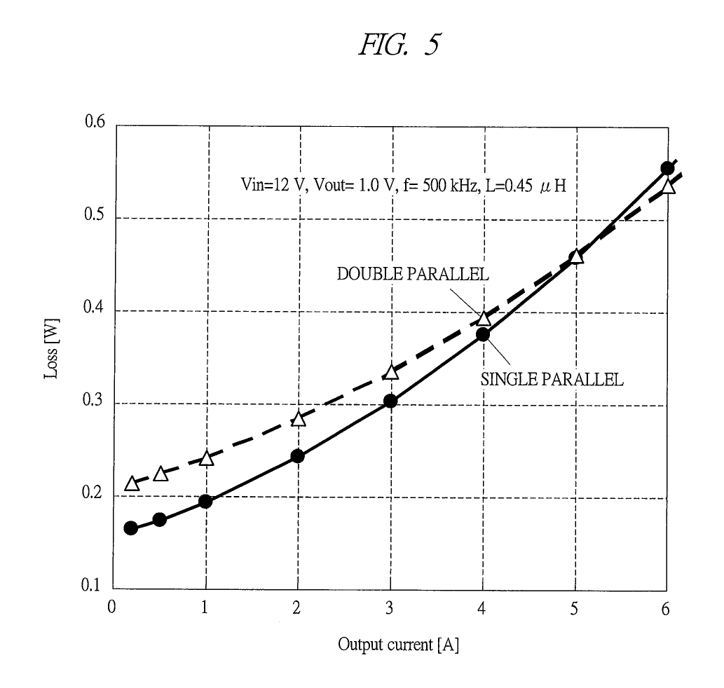

Next, the operation of the power supply unit according to the first embodiment of the present invention will be described with reference to FIG. 2 to FIG. 5. FIG. 2 is a diagram showing an output current waveform in the operation of the power supply unit according to the first embodiment of the present invention, FIG. 3 is a diagram showing an input and an output of the hysteresis comparator in the operation of the power supply unit according to the first embodiment of the present invention, and FIG. 4 and FIG. 5 are diagrams showing the relation between the output current and the loss in the operation of the power supply unit according to the first embodiment of the present invention.

As shown in FIG. 2, in the present embodiment, when the output current lout of the power supply is changed by the sensing MOS 25 mounted in the main MOS 22, the number of power MOSFETs to be connected out of the two power MOSFETs connected in parallel (22, 23) is switched. Here, the area of the main MOS 22 and the area of the sub MOS 23 are equal to each other.

In the region (1) of FIG. 2 (region in which two MOSFETs connected in parallel are operated (hereinafter, referred to as double parallel operation region)), the output current equally flows in both the main MOS 22 and the sub MOS 23. In the region (1) of FIG. 2, the output current decreases with time, and the double parallel operation is switched to the operation of the one MOSFET (hereinafter, referred to as single parallel operation) at the time T1. The drain current of the main MOS 22 at this time is defined as “threshold current I1”.

In the region (2), the single parallel operation is performed, and the single parallel operation is switched to the double parallel operation at the time T2. When the drain current of the main MOS 22 is defined as “threshold current I2”, I2>I1 is established. Since the threshold value of the drain current of the main MOS 22 differs between “switching from double parallel operation to single parallel operation” and “switching from single parallel operation to double parallel operation”, the hysteresis comparator 33 deals with the two current threshold values (I1 and I2).

Note that the present embodiment has been described based on the example using the hysteresis comparator 33, but the embodiment is not limited to this and any comparator or circuit other than the hysteresis comparator may be used as long as it can detect the threshold current I1 of the drain current of the main MOS 22 in the switching from the double parallel operation to the single parallel operation and the threshold current I2 of the drain current of the main MOS 22 in the switching from the single parallel operation to the double parallel operation and further can switch the output signal.

As shown in FIG. 3, the hysteresis comparator 33 outputs the output of the single parallel operation and the output of the double parallel operation as the output voltage vout with respect to the input voltage yin proportional to the drain current of the main MOS 22. Also, arrows in FIG. 3 indicate the time-series changes.

The reference numbers (1), (2) and (3) in FIG. 3 correspond to the numbers of FIG. 2. The solid line shows the range of the double parallel operation and the dotted line shows the range of the single parallel operation.

With the decrease of the output current in the region (1) of the double parallel operation, the input yin of the hysteresis comparator 33 is reduced, and when the threshold value at which the double parallel operation is switched to the single parallel operation is reached at the time T1, the double parallel operation is shifted to the single parallel operation.

Thereafter, in the region (2), the output current increases, and when the threshold value at which the single parallel operation is switched to the double parallel operation is reached at the time T2, the single parallel operation is shifted to the double parallel operation and the region (3) continues at the higher output current.

Here, the loss in the case of the single parallel operation and the double parallel operation will be described.

In the diagram shown in FIG. 4, the solid line indicates the case of the single parallel operation and the dotted line indicates the double parallel operation.

In FIG. 4, in the region where the output current is 5 A or higher, the loss is lower in the double parallel operation, and in the region where the output current is 5 A or lower, the loss is lower in the single parallel operation. FIG. 5 corresponds to the diagram showing the region of 6 A or lower of FIG. 4 in an enlarged manner, and it can be understood that the loss is lower in the single parallel operation in the region of 5 A or lower.

From the foregoing, the low loss (=high efficiency) can be achieved over the wide current range by using the single parallel operation in the range where the output current is 5 A or lower and the double parallel operation in the range where the output current is 5 A or higher.

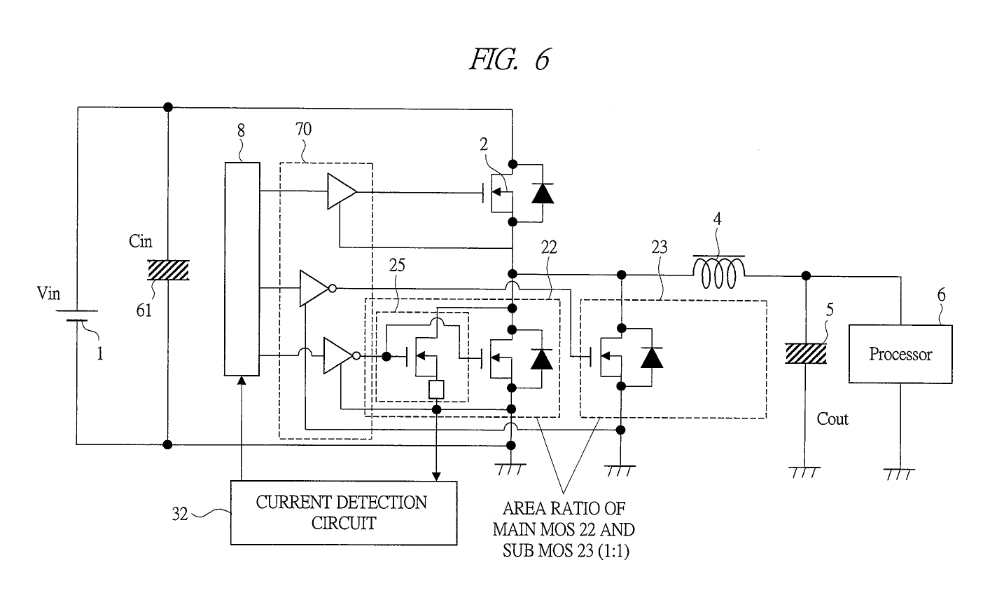

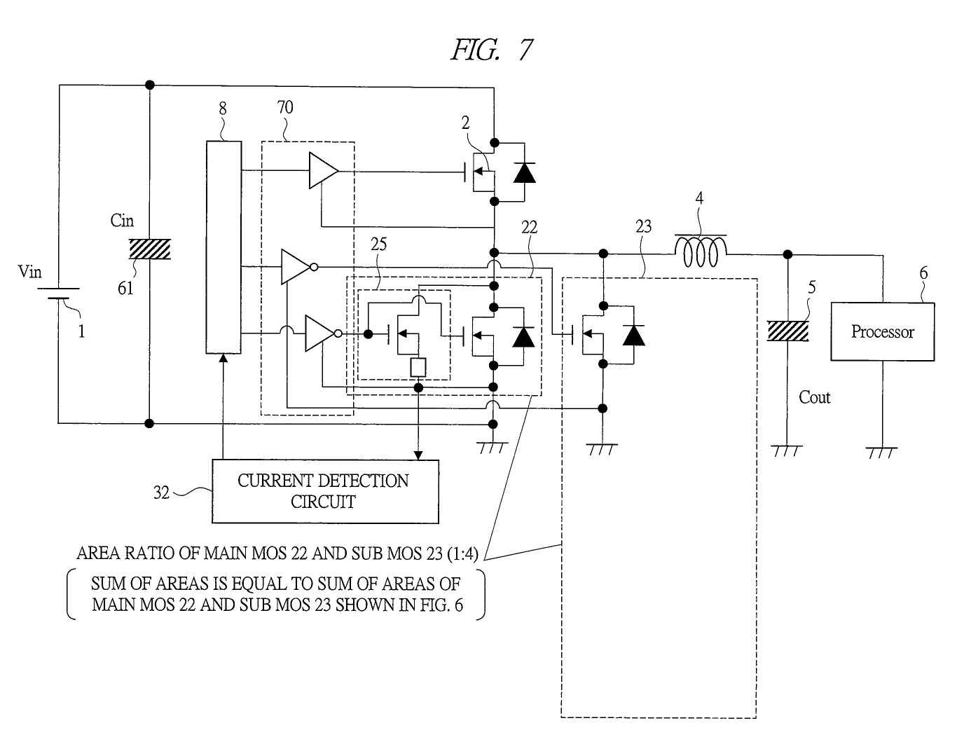

Next, the circuit configuration of the power supply unit according to the first embodiment of the present invention will be described with reference to FIG. 6. FIG. 6 is a circuit configuration diagram showing the circuit configuration of the power supply unit according to the first embodiment of the present invention.

In FIG. 6, a power supply circuit is made up of a DC input power supply 1, a high-side power MOSFET 2 and low-side power MOSFETs (22, 23) functioning as switching elements, a sensing MOS 25, a choke coil 4, a smoothing capacitor 5, a load 6 such as a processor, a control circuit 8 and a driving section 70.

The sensing MOS 25 is provided with, for example, a detecting resistor or the like by which the sensing MOS 25 detects the current, and the information of the current is output from the detecting resistor or the like to a current detection circuit 32. Note that the detecting resistor is not limited to this and others may be used as long as the current can be detected by the sensing MOS 25.

In FIG. 6, the current detection circuit 32, the control circuit 8 and the driving section 70 correspond to the control section 31 shown in FIG. 1.

Also, while the high-side power MOSFET 2 is the single parallel connection, the low-side power MOSFET is the double parallel connection and is made up of the main MOS 22 which is always operated and the sub MOS 23 whose operation is stopped in the light load. Furthermore, the area ratio of the main MOS 22 and the sub MOS 23 is 1:1.

The reason why the loss reduction effect is larger when the double parallel connection is used for the low-side MOSFET than when it is used for the high-side MOSFET will be described below.

A non-isolated DC/DC converter as shown in FIG. 6 is used for the power supply which supplies power to an LSI which consumes relatively high current such as a high-performance processor. Since the input voltage Vin1 of a server and a desktop personal computer is 12 V and the operation voltage of the LSI to be the load 6 is about 1 V, the duty of the high-side power MOSFET 2, that is, the period in which the current flows in the high-side power MOSFET 2 is 10% or less of the full cycle.

On the other hand, since the period in which the current flows in the low-side power MOSFETs (22, 23) is 90% or more of the full cycle, the low-side power MOSFETs (22, 23) have higher conduction loss than the high-side power MOSFET 2.

Therefore, the larger chip size than that of the high-side power MOSFET 2 or the parallelly connected configuration is used for the low-side power MOSFETs (22, 23). Accordingly, the drive loss of the low-side power MOSFETs (22, 23) is increased, and the effect of reducing the drive loss achieved by reducing the number of MOSFETs to be operated out of the parallelly connected low-side power MOSFETs (22, 23) in the light load is large.

Note that the area ratio of the main MOS 22 and the sub MOS 23 is set to 1:1 in the present embodiment, but the area ratio of the main MOS 22 except the sensing MOS 25 and the sub MOS 23 may be set to 1:1.

### Second Embodiment

In the second embodiment, the area ratio of the main MOS 22 and the sub MOS 23 connected in parallel of the low-side power MOSFET in the first embodiment is changed to 1:4.

The circuit configuration of the power supply unit according to the second embodiment of the present invention will be described with reference to FIG. 7. FIG. 7 is a circuit configuration diagram showing the circuit configuration of the power supply unit according to the second embodiment of the present invention.

In FIG. 7, the second embodiment is different from the first embodiment shown in FIG. 6 in that the area ratio of the main MOS 22 and the sub MOS 23 connected in parallel of the low-side power MOSFET is 1:4.

The sum total of the area of the main MOS 22 and the sub MOS 23 is equal to that of the first embodiment shown in FIG. 6. Since the area of the main MOS 22 is reduced, the drive loss is reduced, and the loss when the output current is significantly decreased is reduced.

Next, the loss in the case where the area ratio of the main MOS and the sub MOS is changed to 1:4 in the power supply unit according to the second embodiment of the present invention will be described with reference to FIG. 8. FIG. 8 is an explanatory diagram for describing the loss in the case where the area ratio of the main MOS and the sub MOS is changed to 1:4 in the power supply unit according to the second embodiment of the present invention. In FIG. 8, the result when the area ratio of the main MOS and the sub MOS is 1:4 is added to the diagram of the relation between the output current and the loss shown in FIG. 5 according to the first embodiment.

In FIG. 8, the plots of the area ratio of 1:4 are shown by white circles. The graph of the area ratio of 1:4 crosses with the graph of the area ratio of 1:1 of the first embodiment at the output current of 2 A, and it can be understood that the loss is low in the region where the output current is 2 A or lower in the present embodiment.

The reason why the loss in the case of the area ratio of 1:4 rapidly increases along with the increase of the output current is that the conduction loss becomes dominant compared with the drive loss.

From the foregoing, in the present embodiment, out of the two power MOSFETs connected in parallel, the area of the main MOS 22 is made smaller than that of the sub MOS 23, so that the loss can be reduced in the lower output current compared with the case of the first embodiment in which the area of the main MOS 22 is equal to that of the sub MOS 23.

Note that the area of the main MOS 22 is made smaller than that of the sub MOS 23 in the present embodiment, and this is because the area of the main MOS is made small in order to reduce the drive loss by utilizing the relation “the area of a MOS is large→the input capacitance (gate capacitance) is high→the drive loss is high”. However, any other configuration may be used as long as the input capacitance of the main MOS can be made lower than the input capacitance of the sub MOS.

Note that, although the area ratio of the main MOS 22 and the sub MOS 23 is set to 1:4 in the present embodiment, it is also possible to set the area ratio of the main MOS 22 except the sensing MOS 25 and the sub MOS 23 to 1:4.

### Third Embodiment

In the third embodiment, the two sub MOSs are provided in the configuration of the first embodiment.

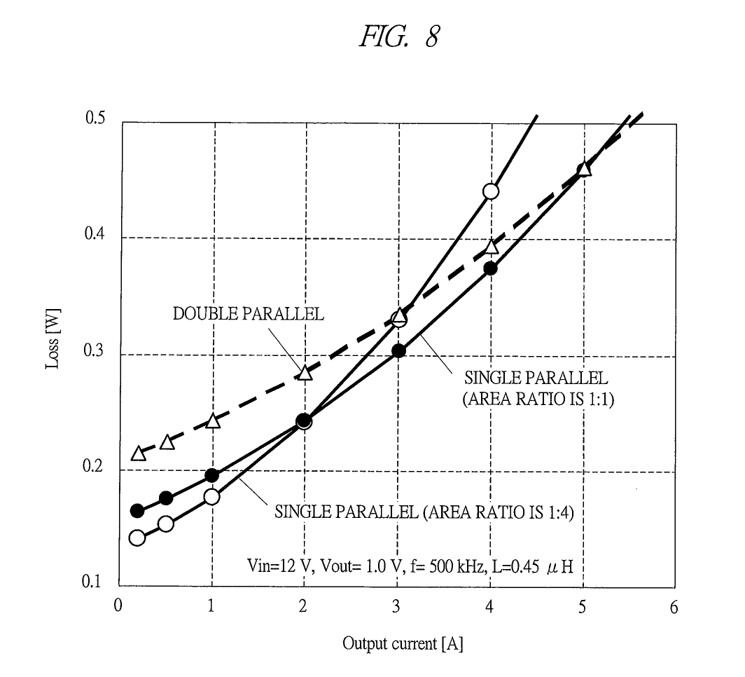

The main configuration of the power supply unit according to the third embodiment of the present invention will be described with reference to FIG. 9. FIG. 9 is a block diagram showing the main configuration of the power supply unit according to the third embodiment of the present invention, and it shows only the periphery of a low-side power MOSFET.

The third embodiment shown in FIG. 9 is different from the first embodiment shown in FIG. 1 in that a sub MOS 41 which is driven by a third gate 42 and whose operation is stopped in the light load is added, three power MOSFETs are connected in parallel, the two sub MOSs (23, 41) are provided, a first comparator 86 and a second comparator 88 are provided, and reference voltage setting circuits (87, 89) which set the reference voltages Vref of the first comparator 86 and the second comparator 88 are provided. The other configuration is the same as that of the first embodiment shown in FIG. 1.

Here, the first comparator 86 determines the drain current of the main MOS 22 when the number of power MOSFETs connected in parallel is reduced, and the second comparator 88 determines the drain current of the main MOS 22 when the number of power MOSFETs connected in parallel is increased.

Since the reference voltages Vref of the first comparator 86 and the second comparator 88 are determined by the number of operating power MOSFETs out of the power MOSFETs connected in parallel, the information of the number of operating power MOSFETs connected in parallel is transmitted from the gate voltage control circuit 34 to the reference voltage setting circuits (87, 89) of the reference voltage Vref.

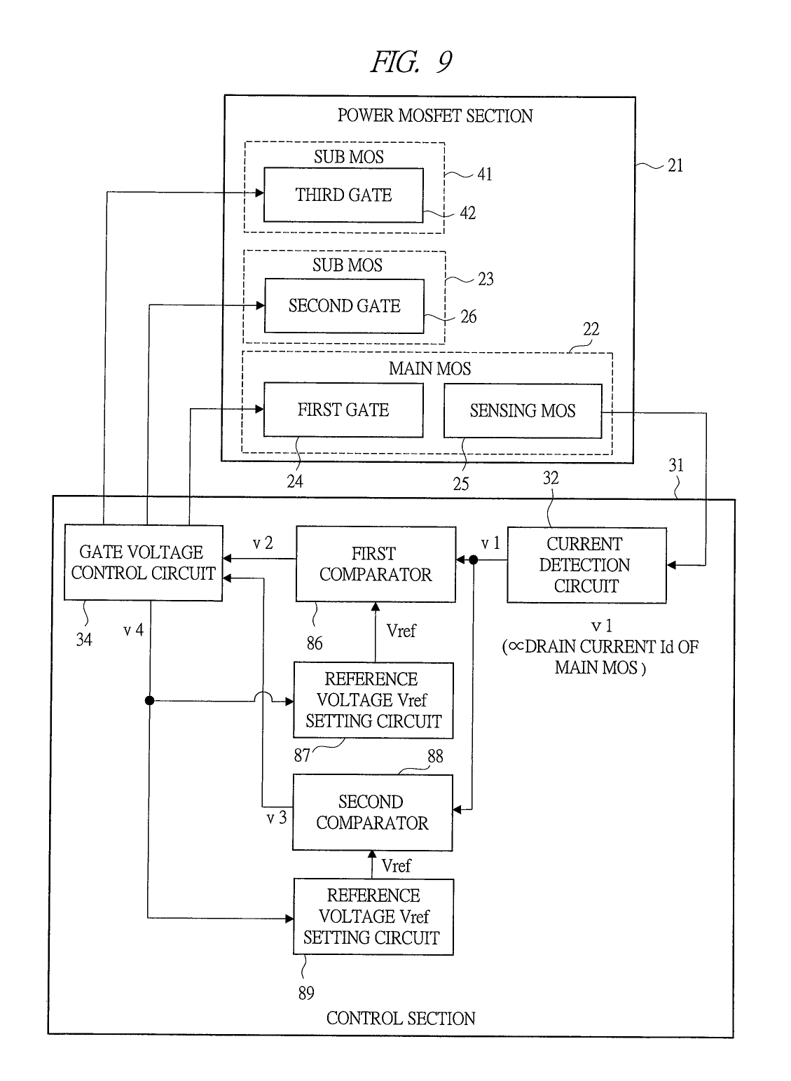

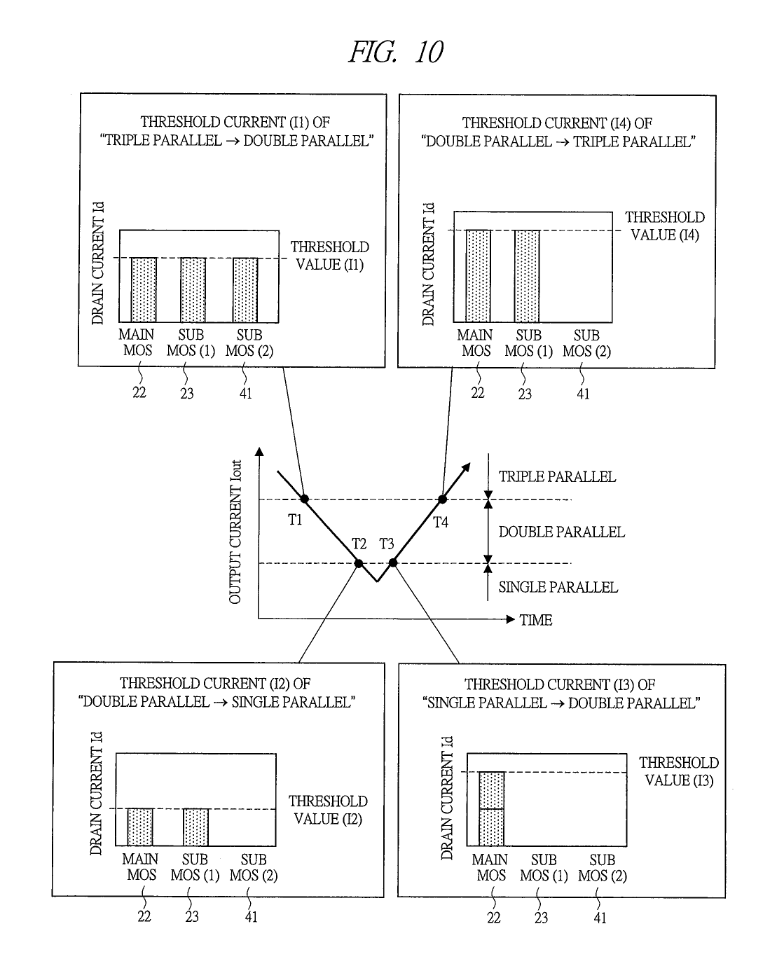

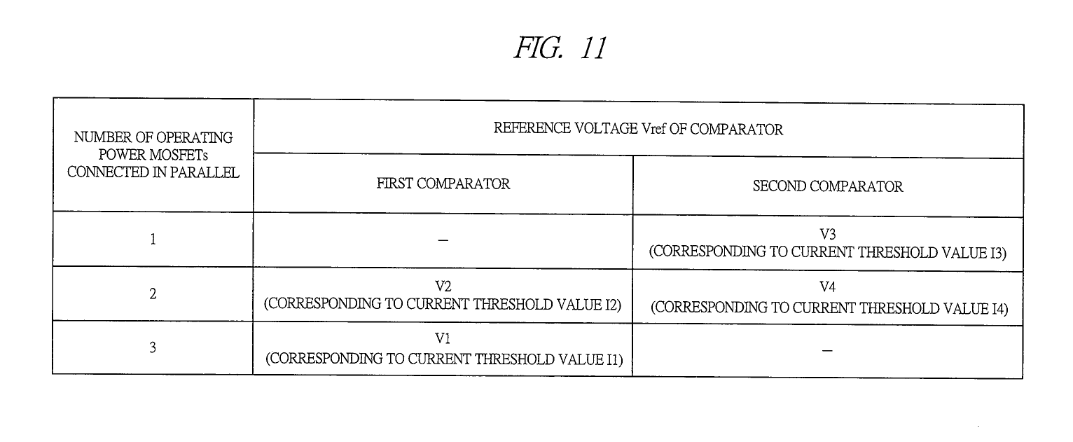

Next, the operation of the power supply unit according to the third embodiment of the present invention will be described with reference to FIG. 10 and FIG. 11. FIG. 10 is a diagram showing an output current waveform in the operation of the power supply unit according to the third embodiment of the present invention, and FIG. 11 is a diagram showing the relation between the number of MOSFETs and the reference voltage of the comparator in the operation of the power supply unit according to the third embodiment of the present invention.

As shown in FIG. 10, in the present embodiment, the number of operating power MOSFETs out of the three power MOSFETs (22, 23, 41) connected in parallel is switched when the output current lout of the power supply is changed by the sensing MOS 25 mounted in the main MOS 22.

Initially, all of the three power MOSFETs connected in parallel are operated, and when the drain current Id of the main MOS 22 reaches a threshold value I1 at the time T1, the operation in which three power MOSFETs connected in parallel are operated (hereinafter, referred to as triple parallel operation) is shifted to the double parallel operation, and the sub MOS (2) 41 stops its operation.

When the drain current Id of the main MOS 22 reaches a threshold value I2 at the time T2, the double parallel operation is shifted to the single parallel operation, and the sub MOS (1) 23 stops its operation. When the drain current Id of the main MOS 22 reaches a threshold value I3 at the time T3, the single parallel operation is shifted to the double parallel operation, and the sub MOS (1) 23 starts its operation.

When the drain current Id of the main MOS 22 reaches a threshold value I4 at the time T4, the double parallel operation is switched to the triple parallel operation, and the sub MOS (2) 41 starts its operation. The threshold values (I1, I2, I3, I4) of the drain current have the relations of I4>I1 and I3>I2.

Since the first comparator 86 and the second comparator 88 deal with the threshold values (I1, I2, I3, I4) of the drain current in the present embodiment, the reference voltages Vref of the first comparator 86 and the second comparator 88 are changed as shown in FIG. 11.

When the number of operating power MOSFETs is two, the reference voltage V2 by which the number is reduced to one is transmitted from the reference voltage setting circuit 87 to the first comparator 86. The reference voltage V2 corresponds to the current threshold value I2 of the main MOS 22 shown in FIG. 10. Furthermore, the reference voltage V4 by which the number is increased to three is transmitted from the reference voltage setting circuit 89 to the second comparator 88, and the reference voltage V4 corresponds to the current threshold value I4 of the main MOS 22 shown in FIG. 10.

When the output v1 of the current detection circuit 32 reaches the reference voltage V2, the double parallel operation is shifted to the single parallel operation, and when the output v1 reaches the reference voltage V4, the double parallel operation is shifted to the triple parallel operation.

Also, when the number of operating power MOSFETs is one, the first comparator 86 is disabled and does not operate. Meanwhile, the reference voltage V3 by which the number is increased to two is transmitted from the reference voltage setting circuit 89 to the second comparator 88, and the reference voltage V3 corresponds to the current threshold value I3 of the main MOS 22 shown in FIG. 10. When the output v1 of the current detection circuit 32 reaches the reference voltage V3, the single parallel operation is shifted to the double parallel operation.

Also, when the number of operating power MOSFETs is three, the second comparator 88 is disabled and does not operate. Meanwhile, the reference voltage V1 by which the number is reduced to two is transmitted from the reference voltage setting circuit 87 to the first comparator 86, and the reference voltage V1 corresponds to the current threshold value I1 of the main MOS 22 shown in FIG. 10. When the output v1 of the current detection circuit 32 reaches the reference voltage V1, the triple parallel operation is shifted to the double parallel operation.

As described above, by switching the number of operating power MOSFETs connected in parallel in three levels based on the output current according to the present embodiment, the loss can be reduced in a wider current range than the first embodiment.

### Fourth Embodiment

In the fourth embodiment, the output of the current detection circuit 32 is converted into a digital signal and a digital control circuit carries out an operation in the configuration of the first embodiment.

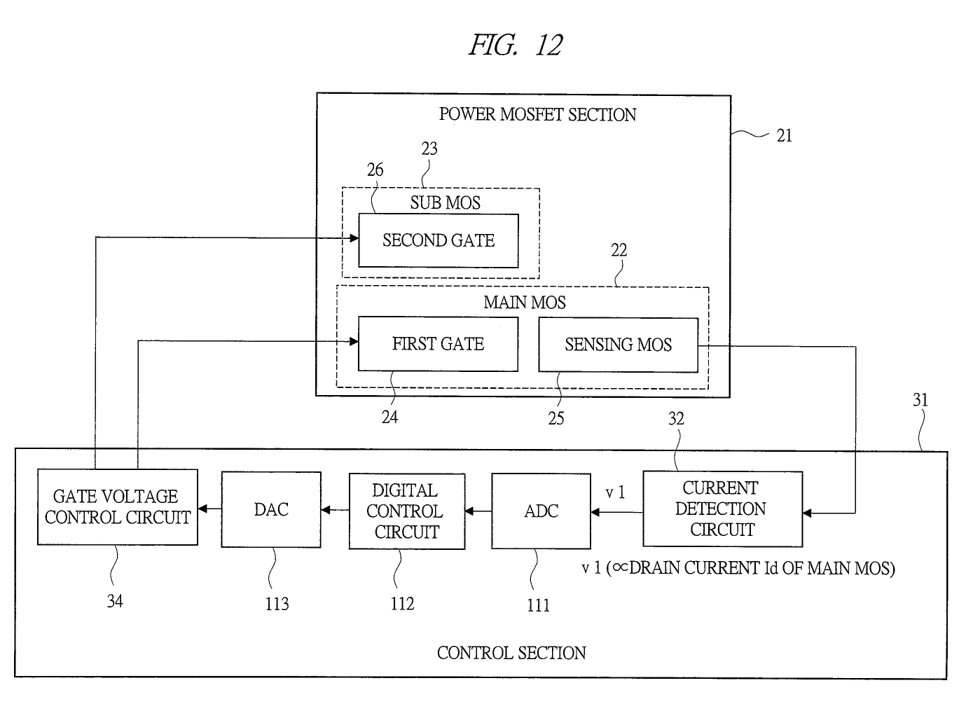

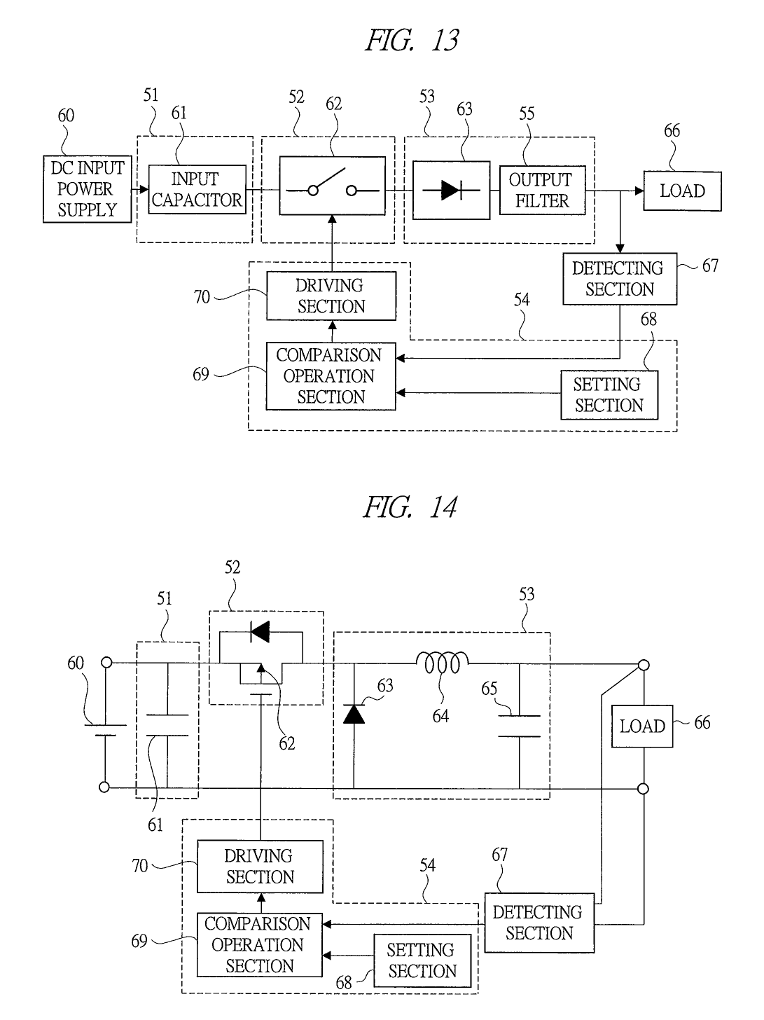

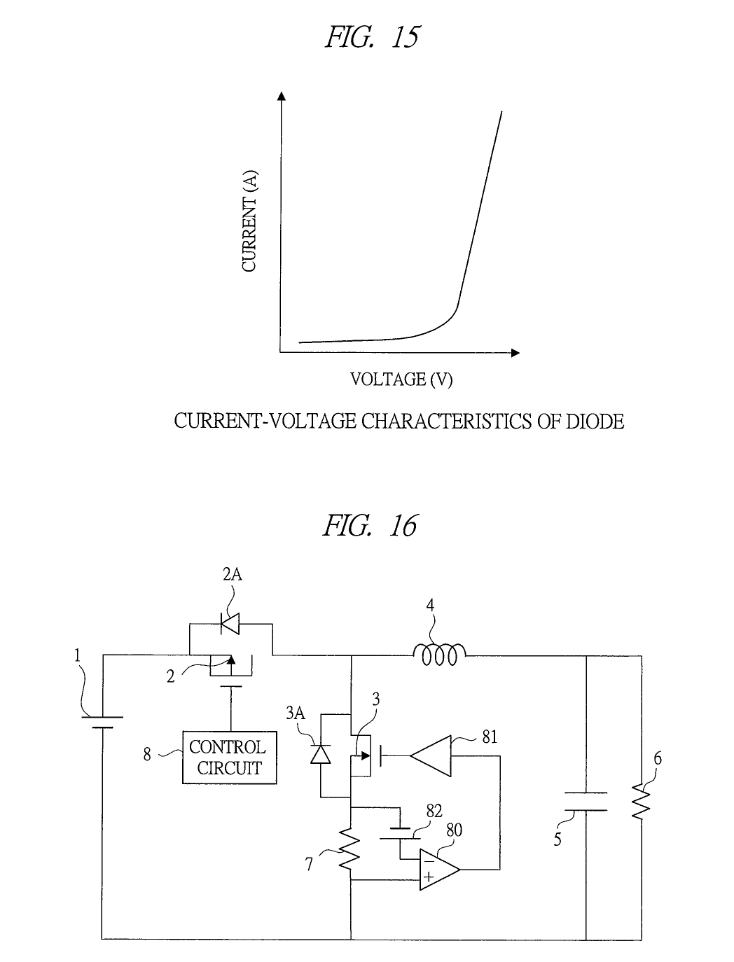

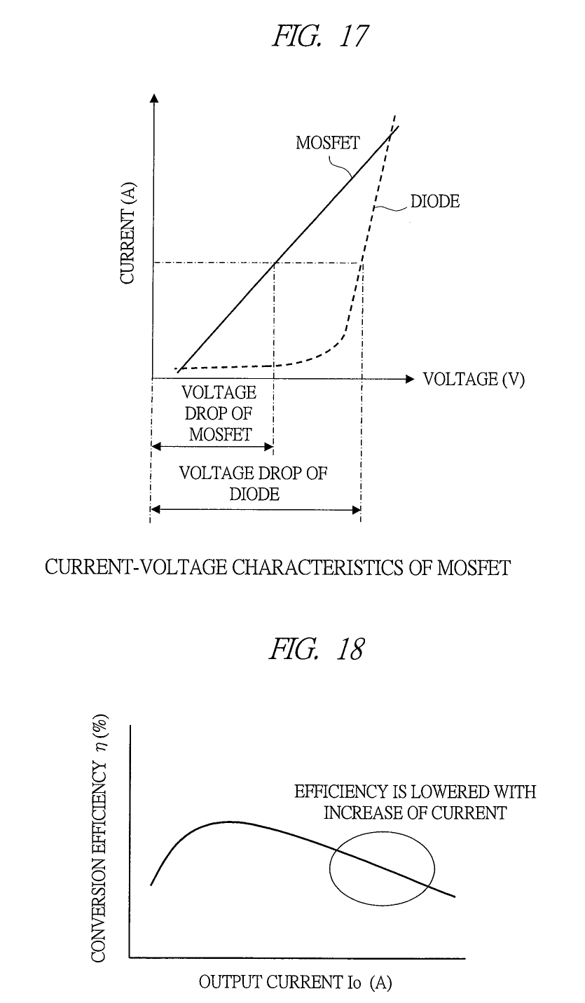

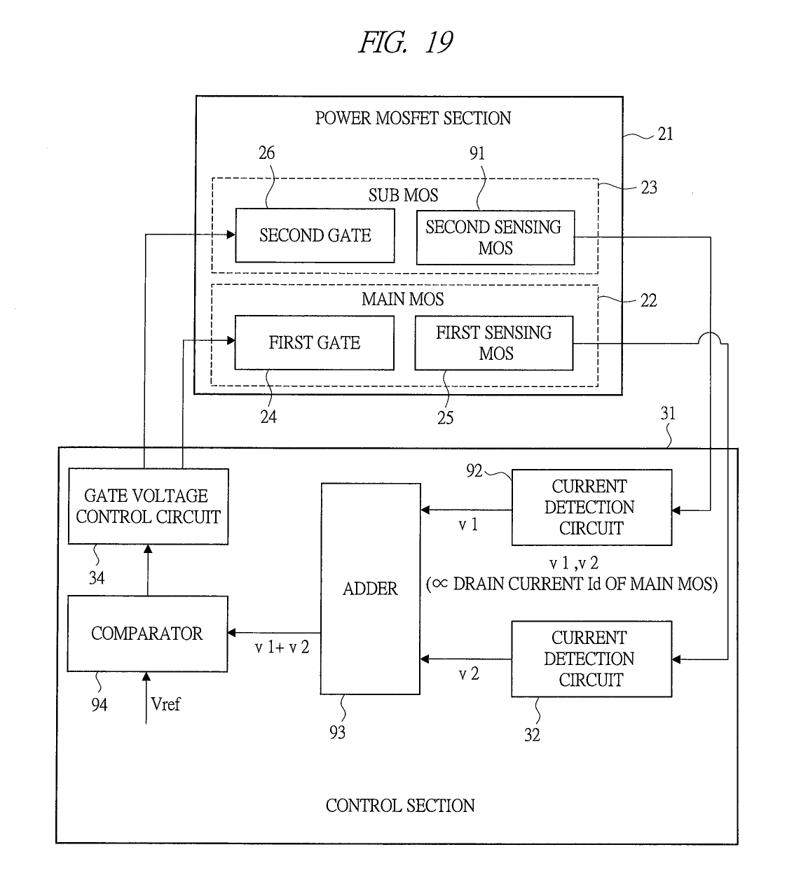

The main configuration of the power supply unit according to the fourth embodiment of the present invention will be described with reference to FIG. 12. FIG. 12 is a block diagram showing the main configuration of the power supply unit according to the fourth embodiment of the present invention, and it shows only the periphery of a low-side power MOSFET.

The fourth embodiment shown in FIG. 12 is different from the first embodiment shown in FIG. 1 in that, in the control section 31, the output voltage v1 of the current detection circuit 32 is converted into a digital signal by using an analog-digital converter (ADC) 111 and a digital control circuit 112 carries out an operation, and then, an operation result is output to the gate voltage control circuit 34 via a digital-analog converter (DAC) 113. The other configuration is the same as that of the first embodiment shown in FIG. 1.

The circuit configuration can be simplified by using the digital control circuit 112 compared with the analog circuit using the comparator in the first to third embodiments.

For example, when the number of power MOSFETs connected in parallel is five and all of the power MOSFETs are operated, the drain current of the main MOS 22 is detected and quintuplicated, thereby obtaining the output current of the power supply. Also, when the number of power MOSFETs connected in parallel is five and three out of the five power MOSFETs are operated, the drain current of the main MOS is detected and triplicated, thereby obtaining the output current of the power supply. Therefore, it is possible to deal with the various parallel operations without changing the circuit configuration of the control section 31.

Note that the number of power MOSFETs connected in parallel is two or three in the description of the first to fourth embodiments, but it is needless to say that the effect of reducing the loss in the light load can be achieved without increasing the size and cost of the power supply unit even when the number of power MOSFETs connected in parallel is four or more.

Furthermore, the case where the power MOSFETs connected in parallel are applied to the low side of a non-isolated DC/DC converter has been described in the first to fourth embodiments, but it is needless to say that the effect of reducing the loss in the light load can be achieved without increasing the size and cost of the power supply unit even when the power MOSFETs connected in parallel are applied to a high side.

Furthermore, the case where the sensing MOS 25 is provided in only the one main MOS 22 has been described in the first to fourth embodiments, but sensing MOSs smaller in number than the number of power MOSFETs connected in parallel may be provided in the main MOS and some of the sub MOSs when the number of the power MOSFETs connected in parallel is three or more.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention relates to a power supply unit and can be widely applied to a power supply unit having a synchronous rectifier circuit used for electronic devices and others.

What is claimed is:

1. A driving method of a switching element in a power supply unit in which a control section complementarily controls on and off of a first switching element and a second switching element connected in series between a voltage input terminal and a reference potential terminal to cause a current to flow in an inductance element connected to a connection node of the first switching element and the second switching element, thereby outputting a voltage obtained by converting a voltage applied to the voltage input terminal,
wherein the second switching element is made up of two or more transistors connected in parallel, detects information corresponding to a load of the second switching element by a sensing transistor which is provided on a same semiconductor substrate with the second switching element and is smaller in number than the transistors connected in parallel of the second switching element, and then outputs the information to the control section, and
the control section makes control based on the information detected by the sensing transistor so as to increase the number of transistors in an off state as the load of the second switching element becomes lighter.

2. The driving method of the switching element according to claim 1,
wherein a current detection circuit provided in the control section and connected to the sensing transistor converts the information corresponding to the load from the sensing transistor into a voltage.

3. The driving method of the switching element according to claim 2,
wherein a comparator provided in the control section and connected to the current detection circuit outputs a signal for controlling on and off of the transistors based on two threshold values.

4. The driving method of the switching element according to claim 1,
wherein at least one transistor out of the two or more transistors connected in parallel of the second switching element has a different input capacitance.

5. The driving method of the switching element according to claim 2,
wherein two or more comparators provided in the control section and connected to the current detection circuit output a signal for controlling on and off of the transistors, and a reference value to determine threshold values of the two or more comparators is changed in accordance with the number of transistors in an on state of the second switching element.

6. The driving method of the switching element according to claim 2,
wherein an analog-digital converter provided in the control section and connected to the current detection circuit converts an output from the current detection circuit into a digital signal, and
a digital control circuit to which the digital signal from the analog-digital converter is input outputs a signal for controlling on and off of the transistors based on the digital signal.

7. A power supply unit comprising:
a first switching element and a second switching element, which is made up of two or more transistors connected in parallel, connected in series between a voltage input terminal and a reference potential terminal;
a sensing transistor which is provided on a same semiconductor substrate with the second switching element, detects information corresponding to a load of the second switching element and is smaller in number than the transistors connected in parallel of the second switching element; and
a control section which complementarily controls on and off of the first switching element and the second switching element to cause a current to flow in an inductance element connected to a connection node of the first switching element and the second switching element, thereby outputting a voltage obtained by converting a voltage applied to the voltage input terminal, and makes control based on the information detected by the sensing transistor so as to increase the number of transistors in an off state as the load of the second switching element becomes lighter.
